(19) United States
(12) Patent Application Publication
(10) Pub. No.: US 2006/0088255 A1
(43) Pub. Date: Apr. 27, 2006

(54) Multi-wavelength optical transceiver subassembly module

(76) Inventors: Enboa Wu, Taipei City (TW); Ying-Ching Shih, Taipei City (TW)

Correspondence Address: LIN & ASSOCIATES INTELLECTUAL PROPERTY, P.O. BOX 2339, SARATOGA, CA, 95070-0339, US

(21) Appl. No.: 10/971,462

(22) Filed: Oct. 22, 2004

(51) Int. Cl. G02B 6/42

(52) U.S. Cl. 385/92

(57) ABSTRACT

Disclosed is an optical transceiver subassembly module for multiplexing and demultiplexing a plurality of channels of different wavelengths. The optical subassembly module includes a transmitter optical subassembly (TOSA) and a receiver optical subassembly (ROSA). For a TOSA, the optical signals emitted by four laser diodes of different wavelengths are combined into a multiplexed optical signal, through respective thin film filters and lenses, which is then coupled onto an optical fiber after passing through a focusing lens. For a ROSA, the input optical signal on the receiver end of the optical fiber is separated into multiple optical wavelength signals, through respective thin film filters and lenses, which are then registered by respective photo detectors. This optical subassembly module with compact star-shaped optics design, active and passive alignments is able to attain high coupling efficiency between optical signals and the optical fiber.

### BACKGROUND OF THE INVENTION

1. Field of the Invention

The present invention relates to a multi-wavelength optical transceiver subassembly module that is applicable to long-haul, metropolitan area network (MAN), and local area network (LAN) signal transmission in telecommunications and data communications.

2. The Related Arts

Optical fiber transmission is instrumental in the development of many advanced applications for telecommunications and data communications. This high bandwidth transmission needs local fiber access to provide two-way communications to the home through an optical transceiver, which is composed of a driver circuit, an electrical subassembly (ESA), and an optical subassembly (OSA). Operation frequency plays a critical role in determining the transmission speed. Conventionally, high speed transmissions up to 10 Gb/sec, 40 Gb/sec, or even higher, is realized by increasing the operation frequency of the transmitter driver circuit, which inevitably leads to a significant increase of manufacturing costs.

Wavelength Division Multiplexing (WDM) was developed to enhance the transmission speed of optical fiber system without undesirably increasing the operation frequency and thus effectively limiting the increase of manufacturing costs. The WDM solution allows an optical transceiver to multiplex a plurality of optical signals of different wavelengths onto a “mixed” signal that can travel along a single optical fiber. Such a “mixed” signal, once reaching a destination receiver, is demultiplexed and separated with the constituent component of the desired wavelength retrieved. In other words, the WDM technology optimizes the utilization of transmission bandwidth by permitting simultaneous transmission of optical signals of different wavelengths over a single optical fiber. Two types of WDM are known, namely Dense Wavelength-Division Multiplexing (DWDM) and Coarse Wavelength-Division Multiplexing (CWDM), based on the minimum size of the spacing between wavelengths of the optical signals that can be composed into the single “mixed” signal.

For DWDM, the normal spacing between two bands of different wavelengths is in the range of 0.8-1.6 nm, so that unitary bandwidth can support extremely high optical signal density. C-band that operates in a bandwidth of 1525-1565 nm is most commonly used for long-haul, MAN and LAN signal transmission. Due to the dense arrangement of optical signals in a single band, optical splitters and photo coupler modules that are employed for DWDM must be upgraded. In addition, a thermoelectric cooler (TEC) that is expensive is needed to control the operation temperature of a laser diode that emits the desired optical signals whereby micro-drifting of the wavelength of the optical signals can be eliminated to ensure transmission quality. All these add to the manufacturing costs, as well as power consumption.

On the other hand, Coarse Wavelength-Division Multiplexing (CWDM) arranges less optical signals in a single optic fiber, which allows for a large spacing (20 nm) between wavelengths of the optic signals. This wavelength spacing is much larger than that of the DWDM. Thus, CWDM does not require the expensive thermo-electric cooler (TEC) to reduce the operation temperature of the laser diode nor to prevent the drifting of the bandwidth.

Although CWDM has a transmission capacity lower than DWDM, such a drawback can be easily overcome by using a number of laser diodes of lower transmission speeds employing CWDM to simultaneously transmit optical signals, and a high speed transmission device compared with DWDM can be realized. For example, to meet a transmission requirement of 10 Gb/sec, CWDM only needs several laser diodes with lower transmission speed, for example laser diodes of 3.125 Gb/sec or 2.5 Gb/sec, which by the nature thereof are more stable in signal transmission, to produce the equivalent performance as a laser diode of 10 Gb/sec. As another example, to reach up to 40 GB/sec transmission, four laser diodes of 10 Gb/sec or slightly higher baud rates together can meet the required specifications. This method can be expanded for even higher transmission bandwidths.

The use of laser diodes of the transmitter optical subassembly (TOSA) with lower transmission speeds allows the sensing area of the corresponding photo diodes on the receiver optical subassembly (ROSA) to be increased. Therefore, the alignment tolerance is less critical and the coupling efficiency between optical signals and optical fiber can be improved.

Also, using laser diodes with lower transmission speeds makes the design for the electrical subassembly (ESA) and driver circuit less critical, but the more challenging part is the design of the optical subassembly (OSA), which is to combine optical signals of different wavelengths and couple them onto a single optical fiber (the part of TOSA), or to separate multiplexed optical signals on the receiver end of the optical fiber into optical wavelength signals to respective photo detectors (the part of ROSA), and at the same time the design spec has to meet the Multi Source Agreement (MSA) and the module miniaturization.

Optical transceivers capable of passive alignment are known, such as U.S. Pat. Nos. 6,198,864 and 6,201,908. The passive alignment is done by inter-engaging two parts of fastening means, such as snap-on fastener, in order to mount a laser diode (for transmitter) or a photo detector (for receiver) to a main body of the transmitter or the receiver with an optical path of the optical signals from the laser diode to the transmitter or from the receiver to the photo detector properly aligned with an optical axis of the transmitter or the receiver. Once the inter-engagement is done, no adjustment for alignment between the optical path and the optical axis is allowed. Thus, for precise alignment, the fastening means must be of high manufacturing precision and this inevitably complicates the manufacturing process and increases the manufacturing costs.

On the other hand, an active alignment technique allows for adjustment of the positions of the laser diode or the photo detector with respect to the transmitter or the receiver in order to obtain an optimum coupling between the laser diode (or the photo detector) and the transmitter (or the receiver). Since no high precision fastening means is needed, the manufacturing costs of the optical transmitter or receivers can be reduced.

The present invention is aimed to overcome the drawbacks of the prior art by employing active alignment technique in the manufacturing of optical transceivers.

### SUMMARY OF THE INVENTION

The primary objective of the present invention is to provide an optical transceiver subassembly module with flexible structure that enables the active alignment of a laser diode or a photo detector relative to an optical transmitter or an optical receiver, thereby enhancing the coupling efficiency between optical signals and an optical fiber.

Another objective of the present invention is to provide an optical transceiver subassembly module that allows for passive alignment for enhancing coupling efficiency between optical signals and optical fibers.

A further object of the present invention is to provide an optical transceiver subassembly having a compact construction by arranging a number of laser diodes or photo detectors in such a way that a star-shaped optical path is formed among the laser diodes or photo detectors, which allows for reduction of overall size to meet the trend of miniaturization.

Yet a further object of the present invention is to provide an optical transceiver subassembly comprising a number of laser diodes respectively located at apexes of a star-shaped optical path, which allows for elimination of reflector for coupling optical signals thereby reducing the overall costs, including both assembling costs and part costs.

To realize the above objectives, the present invention provides an optical subassembly module for multiplexing and demultiplexing a plurality of channels of different wavelengths, which comprises an optical transmitter and an optical receiver, wherein the optical transmitter comprises a plurality of laser diodes and the optical receiver comprises a plurality of photo detectors.

On the transmitter end, laser beams emitted by the laser diodes with different wavelengths are substantially collimated through respective lenses. These optical signals are combined into a signal multiplexed optical signal through respective thin film filters. The multiplexed optical signal is then coupled onto an optical fiber through another lens.

On the receiver end, the optical signal is substantially collimated after passing through a lens, and then separated into optical signals of the original wavelengths after passing through respective thin film filters. These optical signals are projected the respective photo detector by passing through respective lens.

To allow for active alignment, the laser diode (or the photo detector) is partially received in an alignment slot defined in a main body of the transmitter (or the receiver) with a predetermined clearance between the laser diode and the slot whereby the laser diode (or the photo detector) is allowed to do two-dimensional movement within the alignment slot to align the optical path of the optical signals from the laser diode (or to the photo detector) with an optical axis of the transmitter (or the receiver) and high coupling efficiency between the optical signals and an optical fiber extending from/to the transmitter/receiver is realized.

The collimation lens for either the transmitter or the receiver are embedded in the main body and retained in the alignment slots. The depth of each alignment slot can be specifically selected with respect to for example the particular wavelength of the laser beam traveling through the alignment slot so as to gain optimum optical coupling and realizing passive alignment.

Further, for a CWDM transmitter or receiver, four- or eight-channel configuration is the best known and widely used one. Taking a four-channel transmitter as an example, in accordance with the present invention, the main body defines four alignment slots, each receiving and retaining a laser diode of a particular wavelength. The laser diodes are arranged at four apexes of a star shape with a channel lens at a fifth apex of the star, which give a star-shaped optical path among the laser diodes. Such a star-shaped arrangement realizes a compact configuration of the transmitter, which in turn reduces the overall size of the transmitter and meets the trend of miniaturization.

Laser beams from the laser diodes at apexes of the star shape are redirected along the star-shaped optical path by thin film filters also arranged at the apexes, except the first one, so as to join the laser beam that has already traveled along the optical path. The star-shaped arrangement allows for elimination of reflector for coupling optical signals. This certainly reduces the manufacturing costs, including costs for assembling and parts.

The optical transceiver subassembly module in accordance with the present invention has the following advantages over prior arts:

(1) The optical subassembly (OSA) of the present invention enables more flexibility in the final assembly of the transceiver and the manufacturing costs can be considerably reduced.

(2) Miniaturization of the overall module size can be realized. The active alignment optics enables the reduction of the required length of the optical pathway, and the coupling efficiency between optical signals and optical fiber can be enhanced.

(3) The active and passive alignment mechanism is capable to compensate for any discrepancy in the fabrication and assembling of passive components, such as lenses, thin film filters and receptacle.

(4) The coupling efficiency between optical signals and optical fiber for multiple light sources of different wavelengths can be optimized.

The present invention will become more obvious from the following description with reference to the accompanying drawings, which show, for purposes of illustration only, a preferred embodiment in accordance with the present invention.

In the drawings:

### BRIEF DESCRIPTION OF THE DRAWINGS

FIG. 1 is a cross-sectional view of an optical transmitter constructed in accordance with the present invention;

FIG. 2 is a cross-sectional view of an optical receiver in accordance with the present invention;

FIG. 3 is a perspective view of a die-on-header type laser diode in accordance with the present invention;

FIG. 4 is a perspective view of a die-on-header type photo detector in accordance with the present invention;

FIG. 5 is a perspective view of the optical transmitter, illustrating an the active alignment process between the optical device and a main body of the optical transmitter; and

FIG. 6 is another perspective view illustrating the active alignment process between the optical device and the main body of the transmitter.

### DETAILED DESCRIPTION OF THE ILLUSTRATED EMBODIMENT

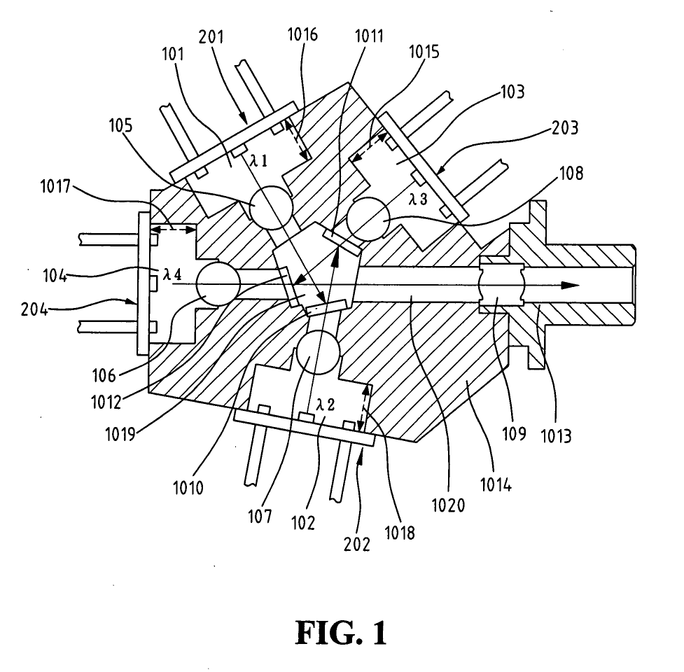

With reference to the drawings and in particular to FIG. 1, an optical transmitter constructed in accordance with the present invention comprises a main body 1014 in which first, second, third and fourth alignment slot 101, 102, 103, 104 are defined. Also defined in the transmitter main body 1014 is a central cavity 1019 that is in communication with each alignment slot 101-104 via a passageway (not shown) that has an axis. The alignment slots 101-104 are of predetermined depths 1016, 1018, 1015, and 1017 to match laser beams of different wavelengths. Each alignment slot 101-104 receives a laser diode device 201, 202, 203, and 204 that a laser beam carrying an optical signal transmits along the associated passageway toward the central cavity 1019. A lens 105, 107, 108, 106, such as a spherical lens, an aspheric lens, and a set of lenses, is retained in each passageway to collimate the laser beam. If desired, surfaces of the lens 105-108 are coated with anti-reflective layers for selective transmission of optical signals with specific wavelengths in order to reduce reflection loss.

The lenses 105-108 can be fixed inside the main body 1014 by ultraviolet curable adhesive, thermosetting adhesive, or other adhesives. Alternatively, glass-to-metal seal may also be employed to fix the lenses 105-108 in the main body 1014. The main body 1014 can be made of plastics whereby the lenses 105-108 can be fixed in the main body 1014 by injection molding of the main body 1014.

The main body 1014 forms a channel 1020 extending from the central cavity 1019 to an opening defined in an outside surface of the main body. A receptacle 1013 is fit to the opening of the channel 1020 for engaging a fiber connector, such as an LC connector, an SC connector, and an FC connector that couples an external optical fiber to the transmitter. Optical signals from the laser diode devices 201-204 is transmitted to the receptacle 1013 in order travel along the optical fiber. A channel lens 109 is retained in the receptacle 1013 for coupling the optical signals onto the optical fiber. The receptacle 1013 can be fixed to the main body 1014 by for example ultraviolet curable adhesive, thermosetting adhesive, or other adhesives. Alternative way for fixing the receptacle 1013 to the main body 1014 includes laser spot soldering and resistive welding.

In order to redirect the laser beams from the laser diode devices 201-204. Optical elements, such as reflectors, are arranged in the central cavity 1019 to receive and reflect/refract the laser beams from the laser diode devices 201-204 in the direction of the channel 1020. In the embodiment illustrated, the optical elements comprise thin film filters 1010-1012, which is capable to transmit an optical signal of a specific wavelength, while reflects optical signals of other wavelengths. The thin film filters 1010-1012 are respectively arranged in positions corresponding to the alignment slots 102-104.

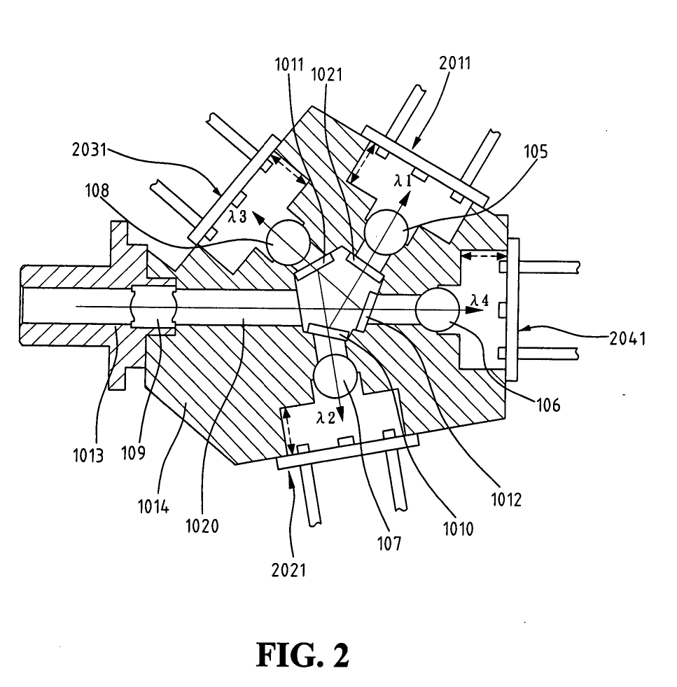

Also referring to FIG. 2, an optical receiver constructed in accordance with the present invention is shown. The optical receiver has a construction that is substantially identical to that of the optical transmitter with reference to FIG. 1 with the laser diode devices 201-204 that emits optical signals replaced by photo detector devices 2011, 2021, 2031, 2041 that detects the optical signals. It is also noted that in the embodiment illustrated, four thin film filters 1010-1012, 1021 are mounted in the central cavity 1019, respectively associated with the four passageways connecting the central cavity 1019 and the alignment slots 101-104. In other words, an additional thin film filter 1021 is arranged between the lens 105 of the first alignment slot 101 and the central cavity 1019.

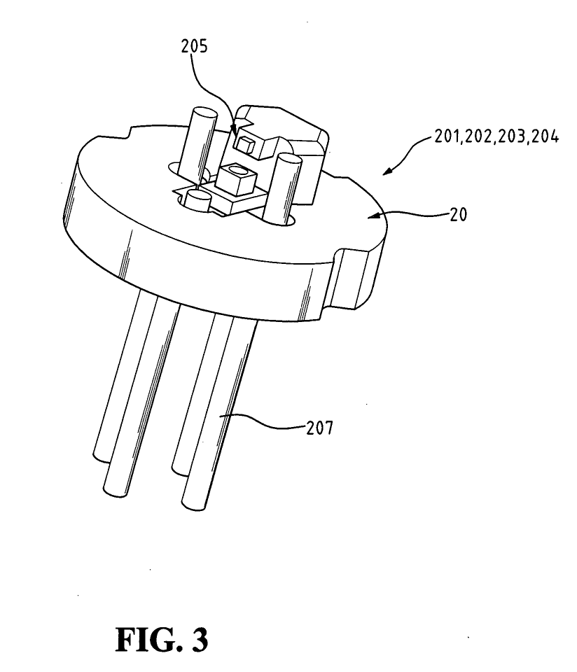

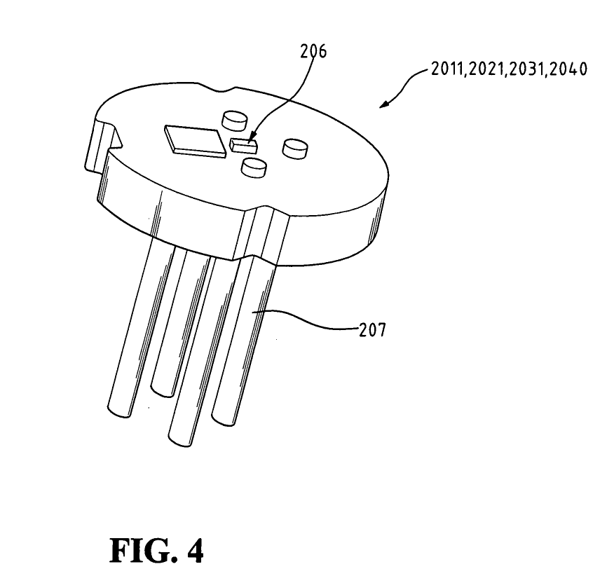

To simplify the description and due to the similarity in construction between the transmitter and the receiver, the laser diode devices and the photo detector devices will be collectively referred to as “optical devices” hereinafter. The optical devices each has a base plate that is positionable on an outer surface of the main body 1014 when the optical devices 201-204, 2011, 2021, 2031, 2041 are received in the alignment slots 101-104. An example of the optical devices, and as illustrated in the drawings, is the so-called die-on-header devices, such as die-on-header type laser diodes particularly shown in FIG. 3 and die-on-header type photo detectors particularly shown in FIG. 4. The die-on-header laser diode (die-on-header photo detector) comprises a diode (a laser diode 205 or a photo diode 206) mounted on a first face of a base plate or a substrate 20 and conductors 207 for external connection of power supply electrically connected to the diode 205, 206 and extending from an opposite second face of the base plate 20. Such a construction is similar to a conventional TO-can package laser diode or photo detector with a lens cap removed.

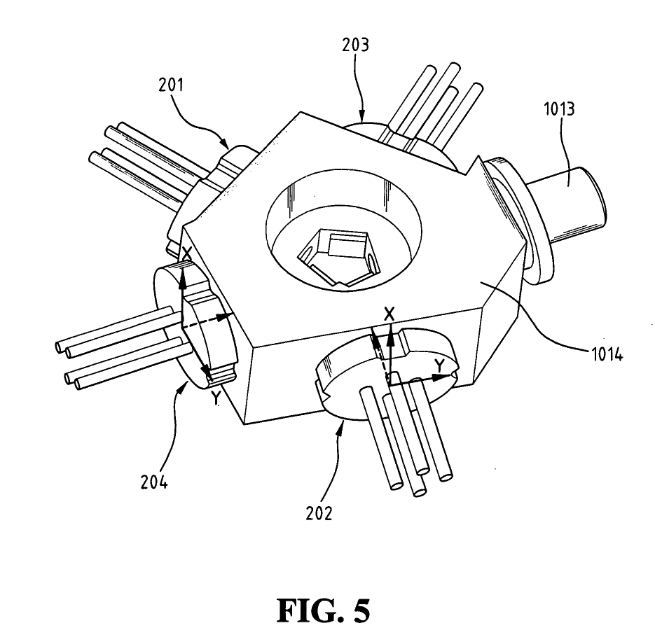

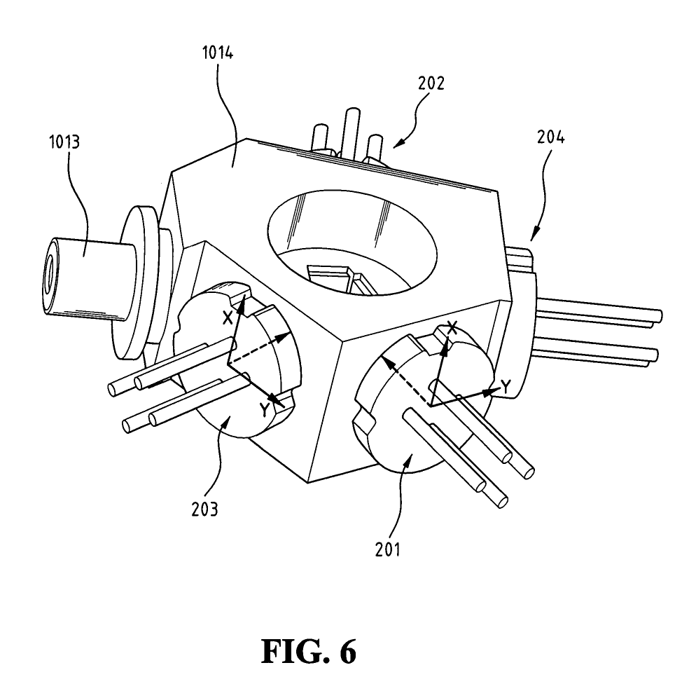

Also referring to FIGS. 5 and 6, the die-on-header optical devices, 201-204, 2011, 2021, 2031, 2041 are mounted to the respective alignment slots 101-104 of the respective main body 1014 with the base plates 20 in contact engagement with an outside surface of the main body 1014 whereby the diodes 205, 206 on the first faces of the base plates 20 are received in the alignment slots 101-104, while the conductors 207 are exposed. The alignment slots 101-104 are of a size that is large enough to allow for movement of the optical devices 201-204, 2011, 2021, 2031, 2041 in the slots 101-104. In other words, clearance is present between the diodes 205, 206 and side walls of the alignment slots 101-104, preferably surrounding the diodes 205, 206, to allow for the movement of the optical devices 201-204, 2011, 2021, 2031, 2041. The base plate 20 of each optical device 201-204, 2011, 2021, 2031, 2041 is slidable on the outside surface of the main body 1014 in both X- and Y-direction as illustrated in FIGS. 5 and 6. It is noted that in the drawings, a third direction of the coordinate system indicated by phantom arrow corresponds to the axis of the passageway associated with the alignment slot 101-104 in which the optical device 201-204, 2011, 2021, 2031, 2041 is received. In other words, the optical device is allowed to displace in a plane normal to the axis. Such a displacement of the optical device 201-204, 2011, 2021, 2031, 2041 allows for perfect alignment of an optical path of the optical signals leaving from/coming toward the optical device with the axis, whereby active alignment can be realized.

Once the alignment is done, the optical device 201-204, 2011, 2021, 2031, 2041 is fixed to the main body 1014 by means of for example adhesives, resistance welding, or laser welding performed between the base plate 20 and the main body 1014.

The other optical components, such as the lens and the thin film filters, are fixed in the main body by passive alignment. In other words, these components are fixed at predetermined position with no spatial adjustment allowed. For example, each lens can be fixed at a particular depth determined in accordance with the particular wavelength associated therewith to ensure optimum collimation. Thus, providing an alignment slot to receive and fix the optical device, and the collimating lens and thin film filter, allows for both active and passive alignments.

In addition, as illustrated in the drawings, the optical devices, 201-204 2011, 2021, 2031, 2041 are fixed to the main body 1014 in such a manner that they are located at four of five apexes of a star-shape, while the channel 1020 is set at the fifth one. This allows for a compact arrangement of the optical devices and the channel in very limited space. The thin film filters embedded in the main body 1014 function to redirect the optical signals from/toward the optical devices 201-204, 2011, 2021, 2031, 2041 along a star-shaped optical path extending among the five apexes. The star-shaped arrangement also eliminates reflector used in conventional optical subassembly.

The operation of the optical transmitter in accordance with the present invention will be described. The laser diode device 201 emits a first laser beam of wavelength λ1 and the laser beam travels through the first alignment slot 101 and transmits through the lens 105, which is then nearly collimated. The beam is then reflected by the thin film filters 1010, 1011, 1012 in sequence to travel in the direction that is coincident with an axis of the channel 1020. Similarly, the laser diode device 202 emits a second laser beam of wavelength λ2 and the laser beam travels through the second alignment slot 102 and transmits through the lens 107, which is then nearly collimated. The second beam further transmits through the thin film filter 1010 and joins and travels with the first beam. Similarly, the laser diode device 203 emits a third laser beam of wavelength λ3 and the laser beam travels through the third alignment slot 103 and transmits through the lens 108, which is then nearly collimated. The third beam further transmits through the thin film filter 1011 and joins and travels with the combined first and second beams. Similarly, the laser diode device 204 emits a fourth laser beam of wavelength λ4 and the laser beam travels through the fourth alignment slot 104 and transmits through the lens 106, which is then nearly collimated. The fourth beam further transmits through the thin film filter 1012 and joins and travels with the combined first, second, and third beams.

Since the first laser diode device 201 is arranged in the first alignment slot 101 in such a way that the optical path of the first laser beam from the first laser device 201 is coincident with the star-shaped optical path, there is no need of a thin film filter associated with the first alignment slot 101. This reduces the number of parts and thus the costs of parts and assembling.

The first, second, third, and fourth laser beams are thus combined as a single beams having components of different wavelengths λ1, λ2, λ3, λ4, that travels along the channel 1020 and transmits through the lens 109 that couples the single combined beam onto the external optical fiber.

The main body 1014 combines laser beams of different wavelengths into a single beam. To obtain optimized results for the laser beam, the focusing depth has to be optimized, for which the required depth varies with the beams of different wavelengths. Through the innovative design of the present invention, the main body 1014 is prefabricated with alignment slots 101-104 having predetermined depths 1015, 1016, 1017, and 1018 for optimized results, wherein each alignment slot 101-104 having a predetermined depth represents the tunable range for focusing on a lens 105, 107, 108 and 106, so that laser beams passing through the lens are nearly collimated. Therefore, the present transceiver is suitable for a variety of applications using short-wave and long-wave optical signal transmissions. Further, the movement of the optical devices 201-204, 2011, 2021, 2031, 2041 with respect to the main body 1014 allows for a two-dimensional adjustment in the X-Y plane during assembly of the optical devices such that the laser diode devices 201-204 can be suitably adjusted to compensate for the assembly errors of other components (for example lens, thin film filter and receptacle), which realizes optimum coupling performance.

The operation of the optical receiver in accordance with the present invention will be described. Optical signals that are received by the receiver moves inside the main body 1014 of the receiver in directions opposite to those inside the transmitter. A laser beam comprised of components of different wavelengths that are multiplexed by for example the transmitter described previously is transmitted to the receiver through an external optic fiber. The laser beams transmits through the channel lens 109 to be collimated, and then travels through the channel 1020 to get incident onto the thin film filter 1012 by which the fourth component laser beam having the wavelength λ4 is separated and is allowed to independently project onto the photo detector device 2041 through the lens 106. The remaining components of the laser beam are redirected by the thin film filter 1012 to sequentially go through the thin film filters 1011, 1010, 1021 by which the third, second and first components of the laser beam having wavelengths λ3, λ2, λ1 respectively are separated one by one. These separated laser beams components are respectively directed toward the associated photo detector devices 2031, 2021, 2011 by the lenses 108, 107, 105. The photo detector_devices 2011, 2021, 2031, 2041 convert the so received optical signals into corresponding electrical signals that are transmitted by the conductors of the photo detector devices to electronics that processes the electrical signals.

Since the optical signals having different wavelengths are routed through different optical paths, the focusing depth for focusing these optical signals precisely onto respective photo detector devices will not be the same, so the focusing depths have to be optimized. In accordance with the present invention, the optical receiver as shown in FIG. 2 has the same features as those found on the optical transmitter with reference to FIG. 1. The alignment slots 101-104 are prefabricated with predetermined depths 1015, 1016, 1017, and 1018 for optimized effects. In addition, through two dimensional adjustment of the positions of photo detector devices 2011, 2021, 2031, 2041 on an X-Y plane, the photo detector devices 2011, 2021, 2031 and 2041 can be tuned to compensate for any assembly error of other optical components, thereby the precision, coupling efficiency, and the power dissipation of the transmitter can be enhanced to attain optimization in link performance.

Since the sensitivity level of the optical receiver only have to match that of the optical transmitter, it is generally sufficient to use the prefabricated alignment slot with predetermined depths 1015, 1016, 1017, and 1018 for assembling of the optical receiver; otherwise, to use the predetermined depths 1015, 1016, 1017, and 1018 of the optical transmitter for optimized results.

Although the present invention has been described with reference to the preferred embodiment thereof, it is apparent to those skilled in the art that a variety of modifications and changes may be made with departing from the scope of the present invention which is intended to be defined by the appended claims.

What is claimed is:

1. A multi-wavelength optical subassembly module, comprising:
a main body having an outside surface in which first, second, third, and fourth alignment slots having first, second, third, and fourth axes respectively and a channel are defined, the alignment slots and the channel being arranged at five apexes of a star shape whereby a star-shaped optical path is formed among the alignment slots and the channel and partly extending along the first, second, third, and fourth axes;
first, second, third, and fourth optical devices received in the first, second, third and fourth alignments slots respectively, and having first, second, third, and fourth optical paths through which first, second, third, and fourth optical signals having first, second, third, and fourth wavelengths travel toward/away from the first, second, third, and fourth optical devices, respectively, wherein each alignment slot is configured and sized to allow for movement of each optical device in a direction substantially normal to the optical path thereof so as to align the first, second, third, and fourth optical paths with the first and second axes respectively;
optical elements arranged inside the main body to redirect the optical signals along the star-shaped optical path and the channel whereby the optical signals are sequentially combined into/separated from a single beam transmitting through the channel;
means for fixing each optical device to the main body.

2. The multi-wavelength optical subassembly module as claimed in claim 1, wherein the optical device comprises a base plate that is positionable and slidable on the outside surface of the main body for the movement of the optical device with respect to the main body.

3. The multi-wavelength optical subassembly module as claimed in claim 2, wherein the optical device comprises a die-on-header optical device.

4. The multi-wavelength optical subassembly module as claimed in claim 1, wherein a collimating lens is arranged inside each alignment slot and each alignment slot has a predetermined optimum depth defined by the wavelength.

5. The multi-wavelength optical subassembly module as claimed in claim 1, wherein the first, second, third, and fourth optical devices comprise first, second, third, and fourth laser diodes, respectively, that emit first, second, third, and fourth laser beams as the first, second, third, and fourth optical signals.

6. The multi-wavelength optical subassembly module as claimed in claim 5, wherein the laser diodes are die-on-header laser diodes.

7. The multi-wavelength optical subassembly module as claimed in claim 5 further comprising first, second, third, and fourth collimating lens through which the first, second, third, and fourth optical signal transmit, respectively, and second, third, and fourth thin film filters, the second thin film filter functioning to redirect the first optical signal along the star-shaped optical path and combine the second optical signal with the first optical signal to form a first combined signal, the third thin film filter functioning to redirect the first combined signal along the star-shaped optical path and combine the third optical signal with the first combined signal to form a second combined signal, and the fourth thin film filter functioning to redirect the second combined signal along the star-shaped optical path and combine the fourth optical signal with the second combined signal to form a third combined signal that travels out of the module through the channel.

8. The multi-wavelength optical subassembly module as claimed in claim 1, wherein the optical devices comprise photo detectors that detect laser beams as first and second optical signals.

9. The multi-wavelength optical subassembly module as claimed in claim 8, wherein the photo detectors are die-on-header photo detectors.

10. The multi-wavelength optical subassembly module as claimed in claim 8, wherein the module is adapted to receive a combined signal comprised of first, second, third, and fourth optical signals and further comprising first, second, third, and fourth thin film filters, wherein the first thin film filter separates the first signal from the combined signal and redirect a combined signal comprised of the remaining second, third, and fourth optical signals along the star-shape optical path, the second thin film filter separating the second optical signal from the combined signal and redirecting a combined signal comprised of the remaining third and fourth optical signals along the star-shaped optical path, and the third thin film filter separating the third optical signal from the combined signal and redirect the remaining fourth optical signal along the start shaped optical path, and also comprising first, second, third, and fourth collimating lens associated with the first, second, third, and fourth thin film filter, respectively for collimating the separated first, second, third, and fourth optical signals.

11. The multi-wavelength optical subassembly module as claimed in claim 2, wherein the base plate has a first face on which an optical transmitting/receiving unit is formed and a second face from which electrical conductors extend, the alignment slot receiving the optical transmitting/receiving unit of the optical device therein with the first face of the base plate positioned on the outside surface of the main body, the alignment slot being sized to form a clearance between the optical transmitting/receiving unit and a side wall of the alignment slot so as to allow for the movement of the optical device with respect to the main body.

12. The multi-wavelength optical subassembly module as claimed in claim 11, wherein the clearance surrounds the optical transmitting/receiving unit so as to allow for two dimensional movement of the optical device with respect to the main body.

13. The multi-wavelength optical subassembly module as claimed in claim 12, wherein a collimating lens is arranged inside each alignment slot and each alignment slot has a predetermined optimum depth defined by the wavelength.

14. A multi-wavelength optical subassembly module, comprising:
a main body;
first, second, third, and fourth optical devices mounted to the main body and emitting/detecting first, second, third, and fourth optical signals; and
a connector mounted to the main body and adapted to connect an external optical element for receiving/transmitting a combined signal comprised of the first, second, third, and fourth optical signals;
wherein the first, second, third, and fourth optical devices and the connector are arranged at five apexes of a star-shape and a star-shaped optical path is formed among the optical devices and the connector along which the combined signal travels

15. A multi-wavelength optical subassembly module, comprising:
a main body having an outside surface defining a slot having a cross-sectional dimension and a depth; and
an optical device received in the slot to transmit/receive an optical signal of a particular wavelength;
wherein the cross-sectional dimension is large enough to form a clearance around the optical device so as to allow for planar movement of the optical device on the outside surface of the main body, while the depth is determined in accordance with the particular wavelength in order to achieve an optimum optical result.
